(19) United States
(12) Patent Application Publication
(10) Pub. No.: US 2014/0233261 A1
(43) Pub. Date: Aug. 21, 2014

(54) DISPLAY DEVICE AND MULTI-DISPLAY DEVICE

(71) Applicant: Sharp Kabushiki Kaisha, Osaka (JP)

(72) Inventors: Hiroyuki Moriwaki, Osaka (JP); Kazutaka Hanaoka, Osaka (JP); Kazuki Kobayashi, Osaka (JP); Kenya Ito, Osaka (JP); Tsuyoshi Inoue, Osaka (JP)

(73) Assignee: Sharp Kabushiki Kaisha, Osaka (JP)

(21) Appl. No.: 14/347,131

(22) PCT Filed: Sep. 20, 2012
(86) PCT No.: PCT/JP2012/005969

§ 371 Date: Mar. 25, 2014

(30) Foreign Application Priority Data
Sep. 27, 2011 (JP) 2011-211117

(51) Int. Cl. F21V 8/00

(52) U.S. Cl. CPC G02B 6/0078
USPC 362/628

(57) ABSTRACT

A display device (100) includes: a display panel (110) having a display area where an image is displayed; a light guide member (150) that has an inner side face (150a) set at an 80 to 110° angle θ to the surface of the display panel (110) and that guides light from the periphery of the display panel (110) to outside of the display area; and a mirror (160) that covers the inner side face (150a) of the light guide member (150).

### TECHNICAL FIELD

The present invention relates to a display device and a multi-display device that performs seamless display using this display device.

### BACKGROUND ART

Large-screen displays for use with digital signage and the like have been in vigorous development recently. In particular, attention has been focused on multi-display devices, which combine a plurality of display devices having ultra-narrow frames to form a large screen.

When combining the plurality of display devices to form a large screen, it is preferable that seamless display be performed without the boundaries of the adjacent display devices being visible.

As shown in FIGS. 10 and 11, a method of making the seams of the display devices harder to see includes providing a light guide member 950 such as a convex lens along the periphery of a display panel 910 so as to cover an opening (window) 930F of a casing 930, thereby displaying magnified images on the periphery of the display panel 910 (Patent Document 1, for example). In FIG. 11, reference character 931 shows a spacer that adheres the display panel 910 and the casing 930 together, and reference character 951 shows an adhesive agent that adheres the light guide member 950 to the display panel 910. A backlight is omitted in FIG. 11.

### RELATED ART DOCUMENT

### Patent Document

Patent Document 1: Japanese Patent Application Laid-Open Publication No. 2010-072522

### SUMMARY OF THE INVENTION

### Problems to be Solved by the Invention

However, when providing the light guide member 950 on the periphery of the display panel 910 as in Patent Document 1, an increase in the size of the display device will also cause the size of the light guide member 950 to increase. If the width of the light guide member 950 is narrowed in order to make the light guide member 950 smaller while maintaining the shape of an outer surface 950b, then the inclination of an inner side face 950a will become steeper. As shown in FIG. 12, if the inclination of the inner surface 950a is made steeper, or in other words, if an angle θ of a display surface 910a of the display panel 910 to the inner surface 950a of the light guide member 950 becomes greater, then as shown by the arrow in FIG. 12, light will be totally reflected by the inner side face 950a and will not exit from the light guide member 950, thus causing a drop in light intensity at the inner side face 950a area and making the display become darker.

The present invention aims at achieving a good display on the periphery of a display device.

### Means for Solving the Problems

A display device of the present invention that solves the above-mentioned problems includes: a display panel having a display area where an image is displayed; a light guide member on the display panel at a periphery thereof having an inner side face set at an 80° to 110° angle to a surface of the display panel, the light guide member covering the periphery and guiding light from said periphery to outside of the display area; and a mirror that covers the inner side face of the light guide member.

With the above configuration, the inner surface of the light guide member is at an 80 to 110° angle to the surface of the display panel with a steep inclination of the inner side face of the light guide member; therefore, the light guide member can be made smaller. Even if the inner side face of the light guide member is at an approximately 80 to 110° angle to the surface of the display panel, the inner side face is covered by a mirror; thus, light can be reliably reflected and a drop in light intensity can be suppressed. Accordingly, an excellent image display can be performed with excellent light intensity on the periphery of the display panel.

In the display device of the present invention, it is preferable that the inner side face of the light guide member be at a 85 to 95° angle to the surface of the display panel.

With the above configuration, the inner side face of the light guide member is at an 85 to 95° angle to the surface of the display panel and the inner surface of the light guide member is approximately perpendicular to the surface of the display panel. Therefore, the minor is difficult to see from the front of the display device. Accordingly, when the viewer sees the screen from the front of the display device, it is difficult for the viewer to see the image inverted by the minor, thus making it possible to achieve an excellent display quality.

In the display device of the present invention, the minor may be a transparent film having an aluminum thin-film or a silver thin-film formed on a surface thereof. Aluminum is inexpensive, has a high reflectance of visible light, and can achieve approximately the same chromaticity for reflected light as the original incident light; thus, it is preferable that the mirror be constituted of an aluminum thin-film. It is also preferable that the mirror be a transparent film with an aluminum thin-film formed on the surface thereof due to being able to cover the inner side face of the light guide member with ease by merely attaching the transparent film with the aluminum thin-film formed on the surface thereof.

The display device of the present invention is preferably used for a multi-display device that includes a plurality of these display devices to provide for large area display. The light guide member is provided on the periphery of the display panel of the present invention and a minor covers the inner side face of the light guide member; therefore, a good display with excellent light intensity can be achieved on the periphery of the display panel, and a multi-display device where the seam portions thereof are hard to see during large-screen display can be provided.

### Effects of the Invention

According to the present invention, even if the light guide member disposed on the periphery of the display panel has an inner side face that is at an 80 to 110° angle to the surface of the display panel, the inner surface of the light guide member is covered by a mirror, and thus, light can be reliably reflected, a drop in light intensity can be suppressed, and a good display with excellent light intensity can be achieved on the periphery of the display panel.

### BRIEF DESCRIPTION OF THE DRAWINGS

FIG. 1 is a schematic image view of an entire configuration of a multi-display device.

FIG. 2 is a view of an assembled state of the displays of the multi-display device.

FIG. 3 is a schematic plan view of a display device according to Embodiment 1.

FIG. 4 is a cross-sectional view of FIG. 3 along the line IV-IV.

FIG. 5 is a schematic plan view of a display device according to Embodiment 2.

FIG. 6 is a cross-sectional view of FIG. 5 along the line VI-VI.

FIG. 7 is a cross-sectional view of primary parts of the display device of Modification Example 1, corresponding to a cross-section of FIG. 5 along the line VI-VI.

FIG. 8 is a cross-sectional view of primary parts of the display device of Modification Example 2, corresponding to a cross-section of FIG. 5 along the line VI-VI.

FIG. 9 is a cross-sectional view of primary parts of the display device of Modification Example 3, corresponding to a cross-section of FIG. 5 along the line VI-VI.

FIG. 10 is a schematic plan view of a conventional display device.

FIG. 11 is a cross-sectional view of FIG. 10 along the line XI-XI.

FIG. 12 is a cross-sectional view of primary parts of the conventional display device when the light guide member has been made smaller, corresponding to a cross-section of FIG. 10 along the line XI-XI.

### DETAILED DESCRIPTION OF EMBODIMENTS

Embodiments of the present invention will be illustratively explained below. The present invention is not limited to the embodiments below. In the drawings, identical or corresponding configurations are shown with identical reference characters.

### Embodiment 1

(Multi-Display Device)

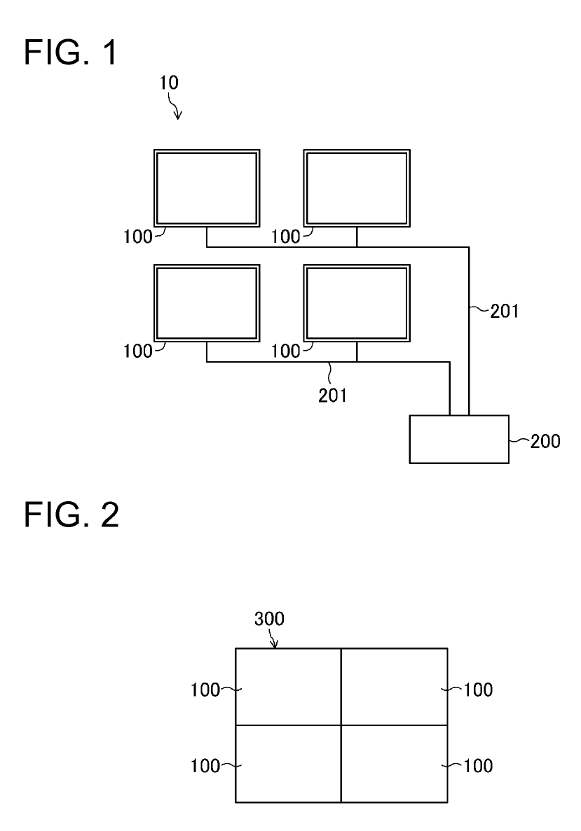

FIG. 1 is a schematic image view of a multi-display device 10. The multi-display device 10 is used for digital signage or the like that performs large-screen display, for example.

The multi-display device 10 has a plurality of display devices 100 (4 in FIG. 1) and a controller 200. The controller 200 communicates with the respective display devices 100 via networks 201. The controller 200 functions to transmit display content to each of the display devices 100, and to perform display mode switching for the display devices 100. The respective display devices 100 may be connected in parallel as shown in FIG. 1, or connected in series by a GPIB (general purpose interface bus) or the like.

FIG. 2 shows a state in which four of the display devices 100 have been integrally assembled. The plurality of display devices 100 altogether form a large-screen display 300. On the basis of commands from the controller 200, the respective display devices 100 may magnify part of an image and then display the image so as to form a single image on the large-screen display 300. Each of the display devices 100 may also display the same image, without magnifying the image (in other words, displaying four images in tile shapes). Each of the display devices 100 may also display different images.

(Display Device)

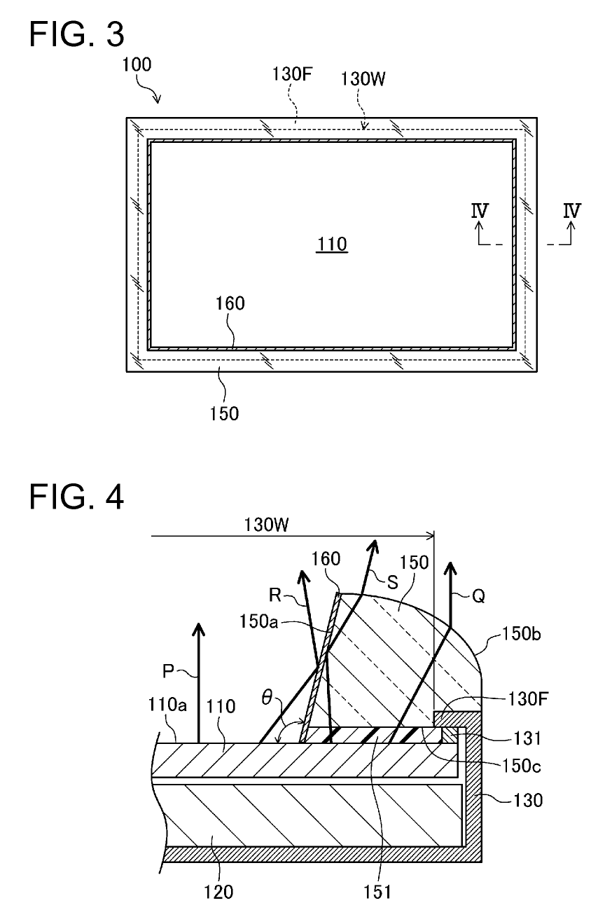

FIGS. 3 and 4 are a schematic plan view of the display device 100 and a cross-sectional view of FIG. 3 along the line IV-IV, respectively.

The display device 100 has a display panel 110 and a backlight unit 120 housed inside a casing 130. The casing 130 has a window 130W disposed therein, and the display area of the display panel 110 can be viewed externally through this window 130W. A light guide member 150 is formed in a frame-shape on the periphery of the display panel 110 and covers the entire periphery.

The display panel 110 has two substrates (not shown) arranged facing each other, and a frame-shaped sealing material is provided between the peripheries thereof. A liquid crystal layer is provided in the region between the substrates surrounded by the sealing material to form a whole liquid crystal display panel. Polarizing plates are respectively provided on the two substrates on the surfaces thereof opposite to the liquid crystal layer. The display panel 110 is an approximately 60-inch display with a vertical length of 747 mm and a horizontal length of 1328 mm, for example.

The backlight unit 120 is arranged to face the surface of the display panel 100 that is opposite to the display side. The backlight unit 120, although not shown, has light sources such as cold-cathode fluorescent lamps or LEDs (light emitting diodes), a light guide plate that guides light from the light sources to the display panel 110, and a diffusion plate, for example. When the light guided by the light guide plate to the display panel 110 passes through the liquid crystal layer, the orientation direction of the liquid crystal molecules adjusts the transmittance of the light, and an image can be seen when the light is emitted from the substrate of the display viewing side.

The casing 130 has the window 130W formed therein, and the images displayed in the display panel 110, which is arranged in the casing 130, can be viewed externally through this window 130W. The portion of the frame-shaped periphery of the casing 130 surrounding the window 130W constitutes a window frame 130F. Frame-shaped spacers 131 are formed on a display surface 110a of the display panel 110 along the periphery, and these adhere the display panel 110 to the inner surface of the window frame 130F of the casing 130.

The light guide member 150 is constituted of a flat inner side face 150a, an outer side face 110b that is expanded in a lens shape, and a flat plane face 150c in contact with the display panel 110. A feature of the present invention is that the inner side face 150a of the light guide member 150 is set at an 80 to 110° angle θ to the display surface 110a of the display panel 110. In the present embodiment, the angle θ is 110°. The light guide member 150 is formed from a transparent material such as an acrylic resin, for example. The light guide member 150 has a width of 10 to 100 mm and a thickness of 10 to 30 mm, for example. If the width of the window frame 130F of the casing 130 is approximately 3 mm, it is preferable that the light guide member 150 have a width of approximately 20 mm and a thickness of approximately 20 mm. The bottom 150c of the light guide member 150 is adhered to the surface of the display panel 110 by an adhesive agent 151 such as an ultraviolet curable resin, a thermosetting resin, or a two-part curable resin.

A mirror 160 is constituted of a transparent film with an aluminum thin-film formed on the surface of the transparent film. The aluminum thin-film is formed on the surface of the transparent film; therefore, both the surface (the surface where the aluminum thin-film is formed) of the transparent film and the surface opposite thereto can reflect light. The minor 160 is constituted of the transparent film, and thus, the minor 160 can be provided with ease by applying the adhesive agent to the transparent film surface and adhering this to the inner side face 150a of the light guide member 150. The surface of the transparent film where the aluminum thin-film is provided may contact the light guide member 150, or the surface of the transparent film where the aluminum thin-film is not provided may contact the light guide member 150. A silver thin-film or the like may constitute the reflective surface of the minor 160 instead of the aluminum thin-film, for example.

The transparent film is made of a material having flexible and light-transmissive characteristics such as polyethylene terephthalate (PET) or triacetyl cellulose (TAC), and has a thickness of 50 to 150 μm, for example. The transparent film serves as the foundation for forming the aluminum thin-film; therefore, in consideration of not scattering the reflected light, it is preferable that the surface of the transparent film be smooth with no recesses or protrusions.

The aluminum thin-film is formed by depositing aluminum on the surface of the transparent film by vapor deposition, and has a thickness of 10 to 500 nm, for example. The surface of the aluminum thin-film constitutes the reflective surface of the minor 160. Aluminum exhibits a high reflectance of visible light, approximately 99%; thus, the light reflected by the reflective surface of the minor has approximately the same chromaticity as the incident light, which makes images shown by the reflected light clearly visible.

In FIG. 4, the outer side face of the light guide member 150 and the outer surface of the casing 130 are shown as one continuous surface, but without being limited thereto, either the outer side face of the light guide member 150 or the outer surface of the casing 130 may be positioned towards the outside.

In this display device 100, the light for image display on the display panel 110 is, on average, emitted perpendicularly to the display panel 110 in the display area where the light guide member 150 is not provided, as shown by an arrow P in FIG. 4. Meanwhile, as shown by an arrow Q in FIG. 4, the light guide member 150 being provided on the periphery of the display panel 110 causes light that exits to the periphery to be refracted by an outer side face 150b of the light guide member 150 when passing through the light guide member 150, thereby progressing towards the outside of the display panel 110. Therefore, images are visible by light guided from the light guide member 150 even on areas of the display panel 110 not contributing to display, such as non-display areas and the window frame 130F of the casing 130.

In this display device 100, the inner side face 150a of the light guide member 150 is covered by the mirror 160; therefore, light that is incident on the mirror 160 from the areas of the display panel 110 not covered by the light guide member 150 is reflected towards the viewer, as shown by an arrow R in FIG. 4.

Meanwhile, light that is incident on the minor 160 from the areas of the display panel 110 covered by the light guide member 150 is reflected back towards the inside of the light guide member 150, as shown by an arrow S in FIG. 4, and this light exits from the outer side face 150b of the light guide member 150 towards the viewer. Thus, the mirror 160 covering the inner side face 150a of the light guide member 150 causes the light from the display panel 110 going through the inner side face 150a of the light guide member 150 to be reflected towards the viewer; therefore, a display can be performed with excellent light intensity even on the inner side face 150a area.

This display device 100 performs a good display with excellent light intensity even on non-display areas due to the light guide member 150, which has the inner side face 150a thereof covered by the mirror 160; thus, even if a plurality of the display devices 100 are assembled to form the multi-display device 10, the borders between these adjacent display devices 100 will be hard to see on the large-screen display 300, thereby making it possible to achieve a good display as a whole.

### Embodiment 2

(Display Device)

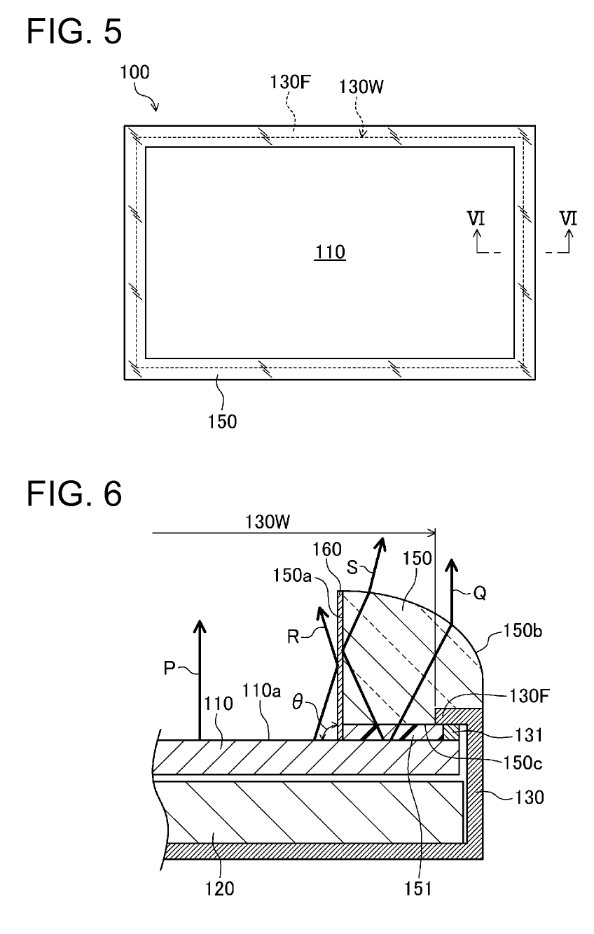

Next, a display device 100 according to Embodiment 2 of the present invention will be explained. In a manner similar to Embodiment 1, the display device 100 forms a multi-display device 10 by a plurality of the display devices 100 being assembled together. FIGS. 5 and 6 are a schematic plan view of the display device 100 and a cross-sectional view of FIG. 5 along the line VI-VI, respectively.

The display device 100 has a display panel 110 and a backlight unit 120 housed inside a casing 130. The casing 130 has a window 130W disposed thereon, and the display area of the display panel 110 can be viewed externally through this window 130W. A light guide member 150 is disposed in a frame-shape on the periphery of the display panel 110.

The display panel 110 has two substrates (not shown) arranged facing each other, and a frame-shaped sealing material is provided between the peripheries thereof. A liquid crystal layer is provided in the region between the substrates surrounded by the sealing material to form a whole liquid crystal display panel. Polarizing plates are respectively provided on the two substrates on the surfaces thereof opposite to the liquid crystal layer. The display panel 110 is an approximately 60-inch display with a vertical length of 747 mm and a horizontal length of 1328 mm, for example.

The backlight unit 120 is arranged to face the surface of the display panel 100 that is opposite to the display side. The backlight unit 120, although not shown, has light sources such as cold-cathode fluorescent lamps or LEDs (light emitting diodes), a light guide plate that guides light from the light sources to the display panel 110, and a diffusion plate, for example. When the light guided by the light guide plate to the display panel 110 passes through the liquid crystal layer, the orientation direction of the liquid crystal molecules adjusts the transmittance of the light, and an image can be viewed when the light is emitted from the substrate of the display viewing side.

The window 130W is formed in the casing 130, and the images displayed in the display panel 110, which is arranged in the casing 130, can be viewed externally through this window 130W. The portion of the frame-shaped periphery of the casing 130 surrounding the window 130W constitutes a window frame 130F. Frame-shaped spacers 131 are formed on a display surface 110a of the display panel 110 along the periphery, and these adhere the display panel 110 to the inner surface of the window frame 130F of the casing 130.

The light guide member 150 is constituted of a flat inner side face 150a, an outer side face 110b that is expanded in a lens shape, and a flat plane face 150c in contact with the display panel 110. A feature of the present invention is that the inner side face 150a of the light guide member 150 is set at an 80 to 110° angle θ to the display surface 110a of the display panel 110 In Embodiment 2, the inner side face 150a of the light guide member 150 is perpendicular to the bottom 150c of the light guide member 150, and the angle θ is 90°. The light guide member 150 is formed from a transparent material such as an acrylic resin, for example. The light guide member 150 has a width of 10 to 100 mm and a thickness of 10 to 30 mm, for example. If the width of the window frame 130F of the casing 130 is approximately 3 mm, it is preferable that the light guide member 150 have a width of approximately 20 mm and a thickness of approximately 20 mm. The bottom 150c of the light guide member 150 is adhered to the surface of the display panel 110 by an adhesive agent 151 such as an ultraviolet curable resin, a thermosetting resin, or a two-part curable resin.

A mirror 160 is constituted of a transparent film with an aluminum thin-film formed on the surface of the transparent film. The aluminum thin-film is formed on the surface of the transparent film; therefore, both the surface (the surface where the aluminum thin-film is formed) of the transparent film and the surface opposite thereto can reflect light. The minor 160 is constituted of the transparent film, and thus, the minor 160 can be provided with ease by applying the adhesive agent to the transparent film surface and adhering this to the inner side face 150a of the light guide member 150. The surface of the transparent film where the aluminum thin-film is provided may contact the light guide member 150, or the surface of the transparent film where the aluminum thin-film is not provided may contact the light guide member 150. A silver thin-film or the like may constitute the reflective surface of the minor 160 instead of the aluminum thin-film, for example.

The transparent film is made of a material having flexible and light-transmissive characteristics such as polyethylene terephthalate (PET) or triacetyl cellulose (TAC), and has a thickness of 50 to 150 μm, for example. The transparent film serves as the foundation for forming the aluminum thin-film; therefore, in consideration of not scattering the reflected light, it is preferable that the surface of the transparent film be smooth with no recesses or protrusions.

The aluminum thin-film is formed by depositing aluminum on the surface of the transparent film by vapor deposition, and has a thickness of 10 to 500 nm, for example. The surface of the aluminum thin-film constitutes the reflective surface of the minor 160. Aluminum exhibits a high reflectance of visible light, approximately 99%; thus, the light reflected by the reflective surface of the minor has approximately the same chromaticity as the incident light, which makes images shown by the reflected light clearly visible.

In FIG. 6, the outer side face of the light guide member 150 and the outer surface of the casing 130 are shown as one continuous surface, but without being limited thereto, either the outer side face of the light guide member 150 or the outer surface of the casing 130 may be positioned towards the outside.

In this display device 100, the light for image display on the display panel 110 is, on average, emitted perpendicularly to the display panel 110 in the display area where the light guide member 150 is not provided, as shown by an arrow P in FIG. 6. Meanwhile, as shown by an arrow Q in FIG. 4, the light guide member 150 being provided on the periphery of the display panel 110 causes light that exits to the periphery to be refracted by an outer side face 150b of the light guide member 150 when passing through the light guide member 150, thereby progressing towards the outside of the display panel 110. Therefore, images are visible by light guided from the light guide member 150 even on areas of the display panel 110 not contributing to display, such as non-display areas and the window frame 130F of the casing 130.

In this display device 100, the inner side face 150a of the light guide member 150 is covered by the mirror 160; therefore, light that is incident on the mirror 160 from the areas of the display panel 110 not covered by the light guide member 150 are reflected towards the viewer, as shown by an arrow R in FIG. 6. Meanwhile, light that is incident on the mirror 160 from the areas of the display panel 110 covered by the light guide member 150 is reflected back towards the inside of the light guide member 150, as shown by an arrow S in FIG. 6, and this light exits from the outer side face 150b of the light guide member 150 towards the viewer. Thus, the minor 160 covering the inner side face 150a of the light guide member 150 causes the light from the display panel 110 going through the inner side face 150a of the light guide member 150 to be reflected towards the viewer; therefore, a display can be performed with excellent light intensity even the inner side face 150a area.

Furthermore, in this display device 100, the inner side face 150a of the light guide member 150 is perpendicular to the display surface 110a of the display panel 110, and thus, the minor 160 is disposed perpendicular to the display surface 110a of the display panel 110. If the display surface 110a of the display panel 110 is not perpendicular to the minor 160, the minor 160 will be visible (see the slashed lines in FIG. 3) when the display device 100 is viewed from the front, but due to the mirror 160 being perpendicular to the display surface 110a, the viewer viewing the display device 100 from the front will not see the minor 160. Accordingly, the viewer will not see images inverted by the mirror, and an even more excellent image display can be performed on the periphery of the display device 100.

This display device 100 performs a good display with excellent light intensity even on non-display areas due to the light guide member 150, which has the inner side face 150a thereof covered by the mirror 160; thus, even if a plurality of the display devices 100 are assembled to form the multi-display device 10, the borders between these adjacent display devices 100 will be hard to see on the large-screen display 300, thereby making it possible to achieve a good display as a whole.

### Other Embodiments

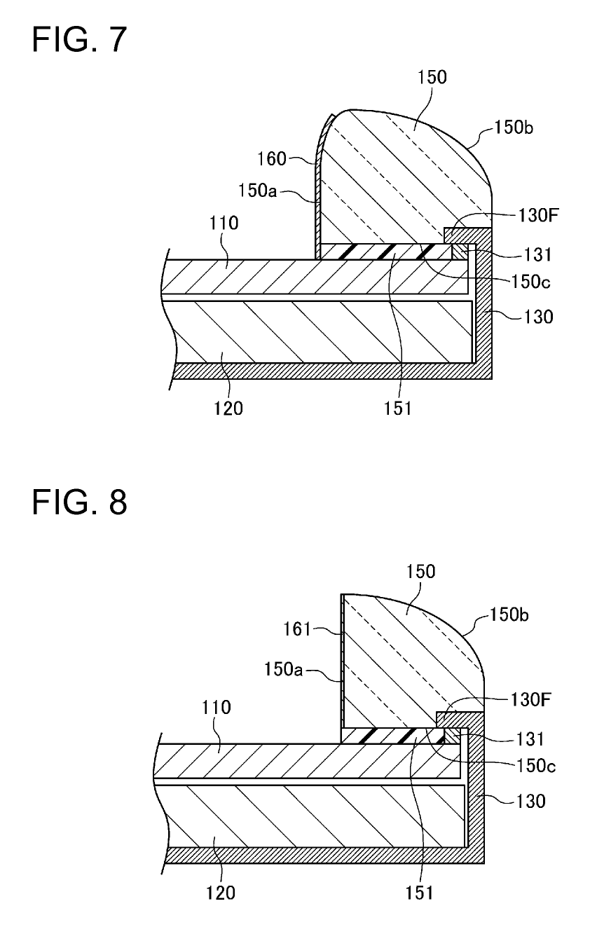

In Embodiments 1 and 2, the inner side face 150a of the light guide member 150 was described as being a flat plane, but the inner side face 150a is not particularly limited thereto. As shown by Modification Example 1 in FIG. 7, the portion of the outer side face 150b of the light guide member 150 adjacent to the inner side face 150a may be curved, for example. Even if the inner side face 150a is curved, the light guide member 150 can be made smaller by the angle of the inner side face 150a to the surface 110a of the display panel being set at 80 to 110°, and an image display with excellent light intensity can be performed on the inner side face 150a area by covering the inner side face 150a with a mirror 160.

In Embodiments 1 and 2 and Modification Example 1, the minor 160 covering the inner side face 150a of the light guide member 150 being a transparent thin film with an aluminum thin-film formed on the surface thereof was described as an example, but as shown by Modification Example 2 in FIG. 8, the inner side face 150a may be covered with a minor by directly depositing an aluminum thin-film 161 on the surface of the light guide member 150 through vapor deposition.

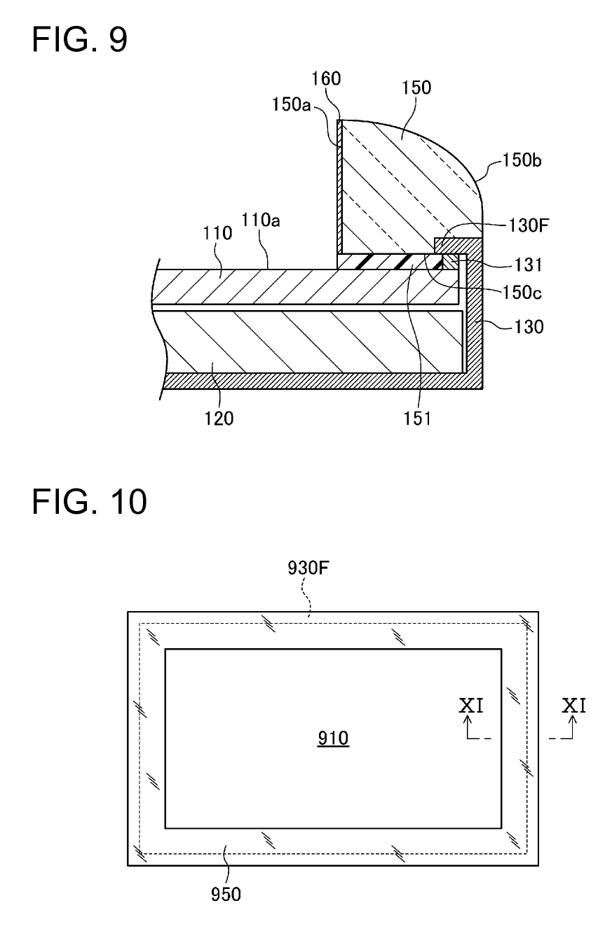

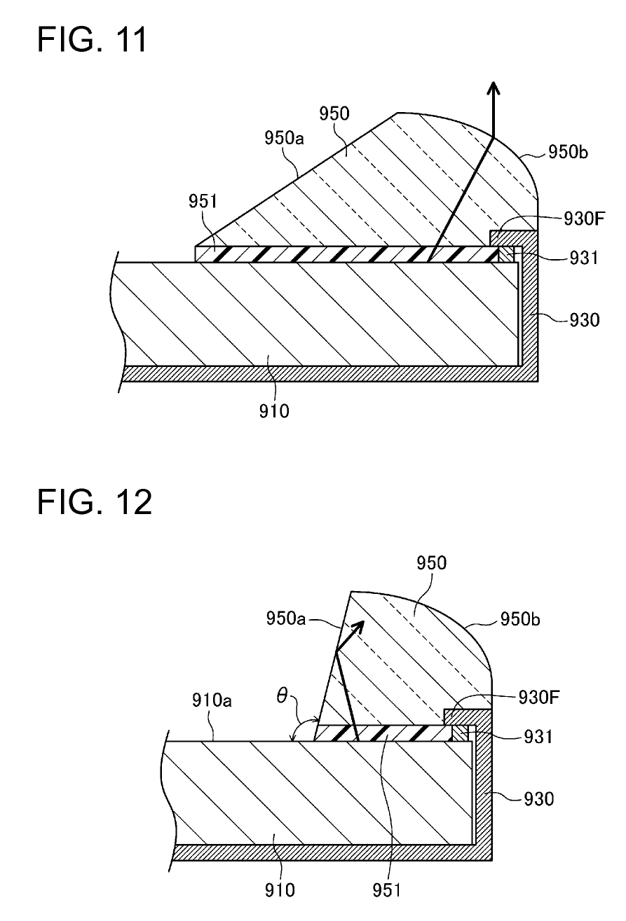

In Embodiments 1 and 2 and Modification Example 1, the minor 160 was described as covering the inner side face 151a of the light guide member 150 and also covering the periphery of the adhesive agent 151, but the minor 160 may be affixed to the light guide member 150 and thereafter the minor 160 may be adhered to the surface of the display panel 110 with the adhesive agent 151. In this case, as shown by Modification Example 3 in FIG. 9, the minor 160 is disposed so as to only cover the inner side face 150a of the light guide member 150 and not the periphery of the adhesive agent 151.

In the respective embodiments and modification examples described above, a liquid crystal display device was described as the display device 100, but without being limited thereto, an organic EL display device, inorganic EL display device, electrophoretic display device, PD (plasma display), PALC (plasma addresses liquid crystal display), FED (field emission display), SED (surface-conduction electron-emitter display), or the like may be used, for example. The display device 100 may also have a drive system for the display panel 110 that is of a field-sequential color type.

### INDUSTRIAL APPLICABILITY

The present invention is useful for a display device, and a multi-display device that performs seamless display using this display device.

### DESCRIPTION OF REFERENCE CHARACTERS

10 multi-display device
100 display device
110 display panel
150 light guide member
150a inner side face
160 minor

1. A display device, comprising:
a display panel having a display area where an image is displayed;
a light guide member on the display panel at a periphery thereof having an inner side face set at an 80° to 110° angle to a surface of the display panel, the light guide member covering the periphery and guiding light from said periphery to outside of the display area; and
a mirror that covers the inner side face of the light guide member.

2. The display device according to claim 1, wherein the inner side face of the light guide member is at an 85° to 95° angle to the surface of the display panel.

3. The display device according to claim 1, wherein the minor is a transparent film having an aluminum thin-film or a silver thin-film formed on a surface thereof.

4. A multi-display device comprising a plurality of the display devices of claim 1 combined together to provide for large area display.

5. The display device according to claim 1, wherein the mirror is a double-sided minor.
